(19) United States
(12) Patent Application Publication
(10) Pub. No.: US 2014/0130538 A1
(43) Pub. Date: May 15, 2014

(54) WOODEN ICE CREAM MAKER

(71) Applicant: NOSTALGIA PRODUCTS GROUP, LLC, Green Bay, WI (US)

(72) Inventors: Gregg Bond, Beverly Hills, CA (US); Edward E. Boughton, III, Ventura, CA (US)

(73) Assignee: NOSTALGIA PRODUCTS GROUP, LLC, Green Bay, WI (US)

(21) Appl. No.: 13/678,505

(22) Filed: Nov. 15, 2012

(51) Int. Cl. A23G 9/22

(52) U.S. Cl. CPC A23G 9/222; A23G 9/224
USPC 62/448

(57) ABSTRACT

An ice cream maker including a canister for holding a mixture of ingredients used to make ice cream, a dasher which fits inside the canister and a drive mechanism for rotating the dasher. The ice cream maker includes an outer bucket formed using individual slats of wood which to provide a generally cylindrical or other shape bucket having inside walls and having a generally circular bottom portion. An insert made of a plastic material is configured to mate with the inside walls and the bottom for holding a freezing mixture into which is inserted the canister with ingredients used to make ice cream.

### BACKGROUND OF THE INVENTION

Ice cream makers for home use are well known machines used to make small quantities of ice cream at home. A first type of ice cream maker stirs the mixture of ingredients used to make ice cream by hand-cranking or with an electric motor, and chills the ice cream by using ingredients having a freezing point below 0° Celsius which surrounds an inner bowl or canister containing the mixture of ingredients used to make ice cream. A second type operates by pre-cooling the machine in a freezer. A third type operates by the machine itself freezing the mixture.

An ice cream maker must freeze the mixture, and must simultaneously stir or churn it to prevent the formation of ice crystals and aerate the mixture to produce smooth and creamy ice cream. Most ice creams are ready to eat immediately after the freezing and churning operation, but some must be chilled further in a freezer to attain a sufficiently firm consistency. Some machines require that the resulting mixture be frozen an extra four hours or more (or overnight), depending on the recipe, in order for the ice cream to harden to a desired consistency.

Ice cream machines of the first type which may be electric or manual usually comprise an outer bowl and a smaller inner bowl with an electric or manually hand-cranked mechanism which turns a paddle, sometimes called a dasher, to stir the mixture. The outer bowl is filled with a mixture of salt and ice. The addition of salt to the ice causes freezing-point depression; as the salt melts the ice, its heat of fusion allows it to absorb heat from the ice cream mixture, freezing the ice cream. The ice and salt mixture has to be replenished to make a new batch of ice cream.

Other variants (the second type) are used such as machines having a double-walled bowl which contains between the two walls a solution that freezes below the freezing point of water. The double-walled bowl is frozen in a freezer for up to 24 hours before the machine is needed. Once frozen, the bowl is put into the machine and the ice cream mixture is added to the bowl. A dasher rotates by hand or motor, stirring the mixture as it gradually freezes through contact with the frozen bowl.

Other variants (the third type) include small freezer-unit machines which sit inside the freezer (or the freezer part of the refrigerator), and operate similar to a food processor in slow-motion. A motor turns the dasher turn every few seconds to stir the ice cream mixture enough to prevent large ice crystals from forming. When the ice cream has frozen sufficiently, the dasher automatically stops rotating and lifts up. As the mixture is cooled simply through being in the freezer, it takes longer to freeze than other types of ice cream makers, which work by placing the ice cream bowl in direct contact with the cooling element. Another variant of the third type includes a freezing compartment in an integrated unit such as described in U.S. Pat. No. 4,551,026.

The present invention is directed to the first type of ice cream machine, that is, a unit with an outer bowl containing an ice and salt mixture to provide a low freezing temperature into which a canister with ice cream ingredients is placed and stirred or churned as described above. The outer bowl or bucket can be made of almost any material, but ice cream makers frequently utilize wooden slats, to provide an old-fashioned look, which are glued or otherwise held together to provide a waterproof seal since as the ice melts, there could be leakage of the resulting water. Although some prior art ice cream makers having a wooden outer bowl include an inner bowl made of aluminum, they are of the second type wherein the bowl which sits inside the wooden outer bowl, and has a double wall construction containing a fluid which freezes at a low temperature as described above. The aluminum bowl is removable so that it can be placed in a freezer to freeze the fluid between its double walls before use. A Cuisinart® ICE-35 available from numerous sources is one example of an ice cream maker of the second type in this category. In the first type of ice cream makers, it is also known to use an outer bowl made of plastic into which the canister containing the ingredients used to make the ice cream is placed such as a Nostalgia Electrics® ICM400Blue available from numerous sources.

The canister containing the ice cream mixture is usually made of aluminum or other material which efficiently transfers the cold temperature produced by the ice and salt mixture outside the canister to the ice cream ingredient mixture inside the canister. The dasher which is driven by the motor or by hand inside the canister can be made of any material, but is frequently made of plastic with a coating to minimize the frozen mixture from sticking to the dasher.

### SUMMARY OF THE INVENTION

The present invention is directed to an ice cream maker of the first type with a wooden outer bowl made of individual slats of wood. However, instead relying on a glue or other material to hold the wooden slats together and provide a seal against leakage of water from melting ice, the invention uses a plastic bucket which is preferably glued or otherwise integrated with the wooden slats to prevent removal of the plastic bucket since, once removed, the plastic can be easily damaged or broken. That is, the wooden slats form a decorative cladding on the plastic bucket so that the plastic bucket and wooden slats form an integrated bucket.

### BRIEF DESCRIPTION OF THE DRAWINGS

FIG. 1 is an exploded view showing the construction of an ice cream bucket made of wooden slats.

FIG. 2 is an exploded view showing a plastic bucket and motor added to the ice cream bucket shown in FIG. 1.

FIG. 3 is an exploded view showing the motor, canister cover, dasher and canister.

FIG. 4 is a perspective view showing the ice cream bucket made of wooden slats with inner plastic bucket.

### DETAILED DESCRIPTION OF THE INVENTION

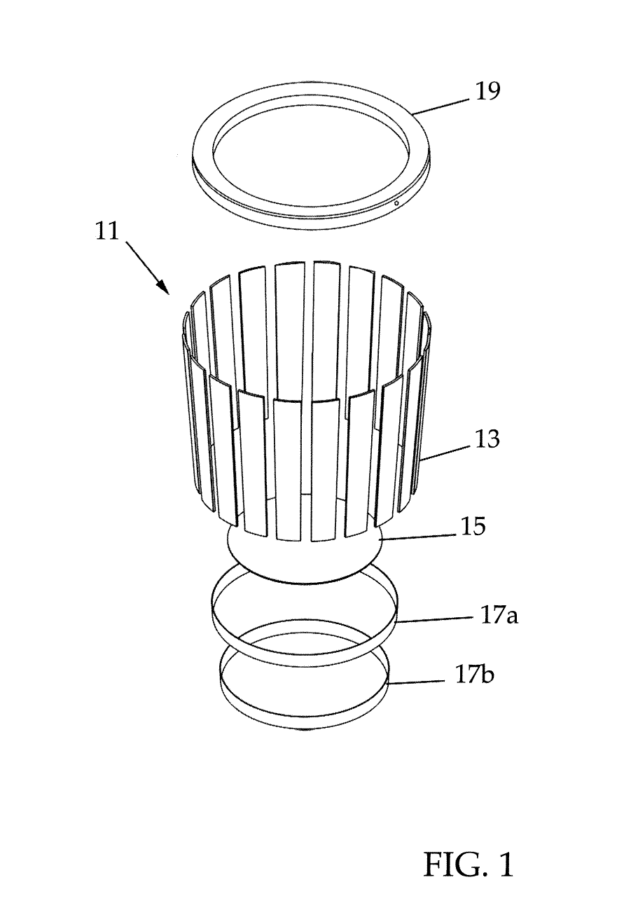

Referring now to FIG. 1, an ice cream maker 11 is shown in exploded view with a bucket formed using wooden slats 13, bottom plate 15, decorative bands 17a and 17b, and decorative ring cap 19. The bottom plate, decorative bands and ring cap can be made of any material, but typically would be made of metal (aluminum, copper, brass) or plastic (injected or plated). The wooden slats may be fitted together using a tongue and groove construction. Alternatively, the wooden slats may be fitted together by keystoned (Voussoir) or butted together. Unlike the prior art, there is no need for a seal, glue or other mechanism to prevent water leakage from the wooden bucket as the salt/ice mixture melts when in use.

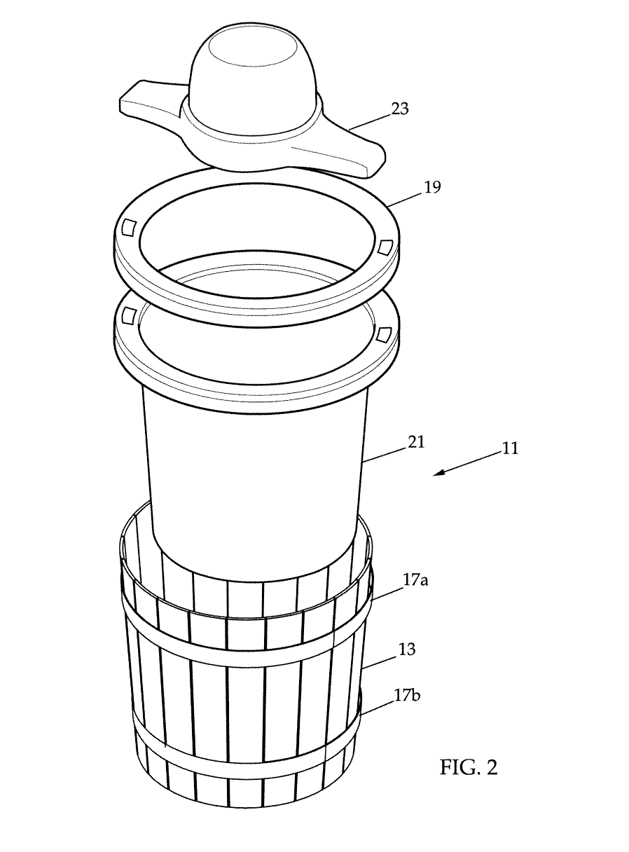

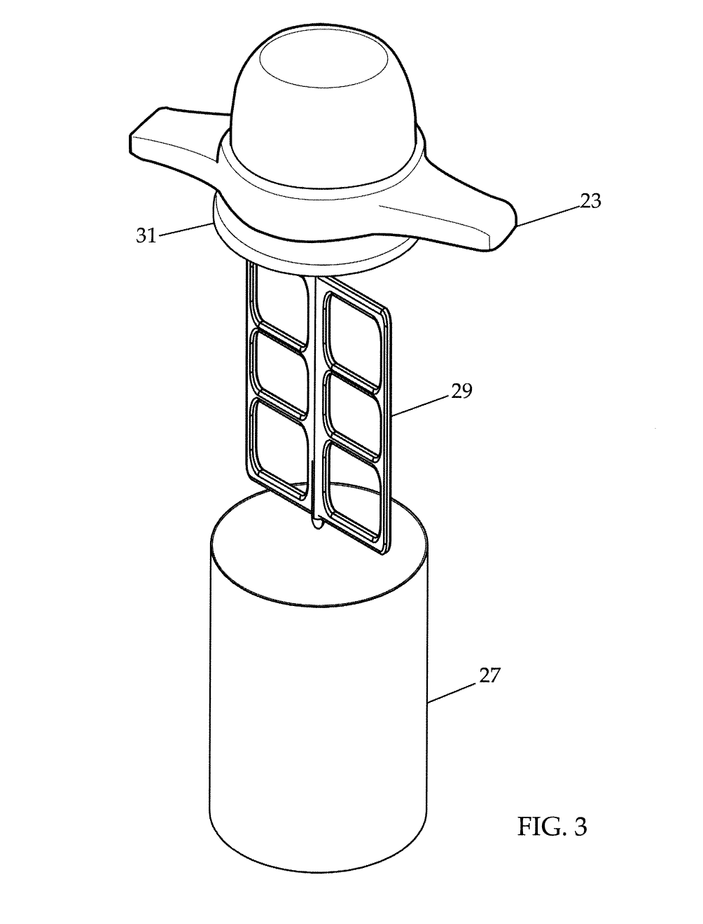

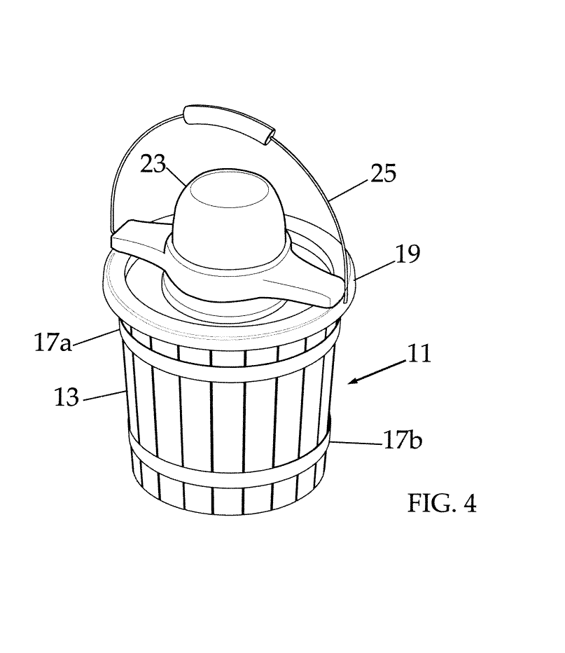

FIG. 2 shows ice maker 11 with wooden slats 13 and decorative bands 17a and 17b as they would normally appear. Also shown in FIG. 2 in exploded view are decorative ring 19, plastic bucket 21, and motor 23. Canister 27, dasher 29 and canister cover 31 are shown in exploded view in FIG. 3 along with motor 23. The wooden slats form a decorative cladding on the plastic bucket so that the plastic bucket and wooden slats form an integrated bucket. Handle 25 shown in FIG. 4 is normally fitted into holes in decorative ring 19 for easy transport of the device. Although the figures show a generally cylindrical bucket, the shape of the bucket can be rectangular or any other desired shape.

As shown in FIG. 2, plastic bucket 21 fits inside wooden slats 13. Preferably, plastic bucket 21 is glued or otherwise fixed in place so that it cannot be removed. FIG. 3 shows a complete ice cream maker according to the invention.

In operation, the invented ice cream maker functions as described above with reference to the type one variant, an ice and salt mixture is placed in plastic bucket 21. A mixture of ingredients used to make ice cream is placed into canister 27. The canister is placed into the ice and salt mixture. Dasher 29 is placed inside canister. The canister is covered with cover 31. A shaft (not shown) protrudes through the cover and is connected to motor 23. The motor is used to turn the dasher as is well known in the art.

By using plastic insert 21 to line the inner walls of the bucket formed using wooden slats 13, an ice cream maker is provided which has the authentic look of an old-fashion ice cream bucket with the convenience of an easy to clean plastic insert and without having a concern that the wooden bucket with the salt and ice mixture will leak due to weakening over time of whatever material is used to waterproof the wooden bucket.

I claim:

1. An ice cream maker including a canister for holding a mixture of ingredients used to make ice cream, a dasher which fits inside the canister and a drive mechanism for rotating the dasher, said ice cream maker further comprising:
a) an outer bucket formed using individual slats of wood having inside walls and a bottom portion; and
b) an insert made of a plastic material configured to mate with said inside walls and said bottom portion for holding a freezing mixture into which is inserted the canister with ingredients used to make ice cream.

2. The ice cream maker defined by claim 1 wherein the insert is permanently coupled to said inside walls.

3. The ice cream maker defined by claim 1 wherein the individual slats of wood are fitted together with a tongue and groove construction.

4. The ice cream maker defined by claim 1 wherein the individual slats of wood are keystoned together.

5. The ice cream maker defined by claim 1 further comprising at least one decorative band surrounding the formed outer bucket.
